(19) United States
(12) Patent Application Publication
(10) Pub. No.: US 2002/0099632 A1
(43) Pub. Date: Jul. 25, 2002

(54) METHOD AND SYSTEM OF CONNECTING AN INTERNET

(76) Inventors: KAZUHIKO YANAGIDATE, KAWASAKI-SHI (JP); YOSHIKI SUZUKI, KAWASAKI-SHI (JP); TERUO TOBE, KAWASAKI-SHI (JP)

Correspondence Address: Katten Muchin Zavis Rosenman, 575 Madison Avenue, New York, NY, 10022-2585, US

(21) Appl. No.: 09/288,394

(22) Filed: Apr. 8, 1999

(30) Foreign Application Priority Data
Jun. 8, 1998 (JP) 10-223355

(51) Int. Cl. G06F 17/60

(52) U.S. Cl. 705/34

(57) ABSTRACT

Internet connection method and system, in which a subscriber terminal having a correct IP address can be connected to the Internet through a bill-charging device by referring a database stored in a customer information management device under a control of a WWW server, are provided. In the Internet connection system having subscriber terminals connected to an IP network, a WWW server receiving a request for connecting the subscriber terminal to the Internet, a customer information management device storing information of the subscriber terminal, and a bill-charging device controlling connections of the subscriber terminals to the Internet, the subscriber terminal transmits a request to connect to the Internet, the www server receives the information of the subscriber terminal corresponding to the IP address of the subscriber terminal from the customer information management device, and the WWW server informs the bill-charging device whether or not the subscriber terminal can connect to the Internet according to the subscriber terminal.

### BACKGROUND OF THE INVENTION

1. Field of the Invention

The present invention relates to a method of connecting an IP network to the Internet and using the method. More particularly, it relates to a method of connecting an IP network employing a cable television (CATV) network to the Internet and a system using the same.

2. Description of the Related Art

In network services for interconnecting a subscriber terminal on an Internet protocol (IP) network with the Internet, a bill-charging device manages to charge for a pay of using the Internet service, according to a packet flowing ratio. In this case, there is a possibility of bringing a problem such that a unintended payment is charged due access made by third parties to a specific subscriber through the Internet.

As a CATV network has been popular in recent years, the CATV network may be also used for an IP network on the CATV network by using a cable modem, and a CATV service company becomes a provider to provide an Internet connection service for end users, who are subscribers of the CATV network. In this case, there is also a possibility to bring the above-described problem such that a unintended payment is charged.

Additionally, in the Internet connection service on the IP network employing the CATV network, a CATV company temporally stops service to a subscriber when the subscriber requests to stop the service or payment to the CATV company has been performed for a certain period.

However, if a terminal device is once removed or the customer data is deleted as stopping the service, it becomes difficult to easily restart the service to the customer.

On the other hand, if an end user is of a corporation or a general home, plural persons share one terminal device for connecting to the CATV network. In this case, there should be for many circumstances to give limitation, so that an end user can access only sites relating to corporate businesses, or children can not access to undesired sites.

### SUMMARY OF THE INVENTION

Accordingly, it is an object of the present invention to provide a method and system for connecting to the Internet to achieve the above-described problems.

The above-described object according to the present invention can be attained by Internet connection method for used in an Internet connection system having subscriber terminals connected to an IP network, a WWW server receiving a request for connecting a subscriber terminal to the Internet, a customer information management device storing information of the subscriber terminals, and a bill-charging device controlling connections of the subscriber terminals with the Internet.

The WWW server receives the information of the subscriber terminal corresponding to the IP address of the subscriber terminal, which transmits a request to connect to the Internet, from the customer information management device and informs the bill-charging device whether or not the subscriber terminal can connect to the Internet according to the information of the subscriber terminal.

Alternatively, in one preferred mode of the present invention, when the WWW server receives a request from the subscriber terminal to finish connecting to the Internet, the WWW server informs the bill-charging device that the subscriber terminal stop connecting to the Internet.

Additionally, in other preferred mode of the present invention, the bill-charging device counts and stores a packet flowing ratio from the time when the subscriber terminal transmits a request to connect to the Internet to the time when the subscriber terminal finishes to connect to the Internet.

Alternatively, in one mode, the WWW server, the customer information management device and the bill-charging device are located in a CATV station, and the IP network is constituted by employing the CATV network.

Additionally, the information of the subscriber terminal stored in the customer information management device includes information of services that the subscriber terminal can receives, and the WWW server controls the bill-charging device to connect the subscriber terminal to the Internet according to the service information.

Further, other objects of the present invention will become clear by the description for explaining embodiments according to the attached drawings.

### BRIEF DESCRIPTION OF THE DRAWINGS

FIG. 1 shows an embodiment according to the present invention. In FIG. 1, a structural example of a system where a CATV network is employed as an IP network to provide the Internet connection service for end users is shown.

FIG. 2 is a structural example of an embodiment of a bill-charging device 30.

FIG. 3 is an explanatory diagram of an outline of a procedure of starting the Internet connection service according to the present invention.

FIG. 4 is a sequential flowing chart corresponding to FIG. 3.

FIG. 5 is a sequential flowing chart when the subscriber finishes to connect the Internet connection service.

FIG. 6 is a sequential flowing chart of an embodiment of extending processes of FIG. 4.

FIG. 7 shows a customer information record, which is registered and formed in each subscriber terminal 20 stored in the customer information management device 32.

FIG. 8 illustrates a service class table.

FIG. 9 illustrates an access condition table.

FIG. 10 illustrates an IP address table.

FIG. 11 shows one method of solving a problem on charging management explained in FIGS. 18 and 19.

FIG. 12 is a relational table of explaining a management system corresponding to the embodiment of FIG. 11.

FIG. 13 is an other embodiment of solving a problem on charging bill explained in FIGS. 18 and 19. It shows an example where a payer ID is installed.

FIG. 14 is a relational table of explaining the management system corresponding to the embodiment of FIG. 13.

FIG. 15 is an other embodiment for solving a problem on charging the bill explained in FIGS. 18 and 19. It shows an example where a representative payer ID is introduced.

FIG. 16 is a relational table of explaining the management system corresponding to FIG. 15.

FIG. 17 is a process flow chart on managing the subscriber employing the present invention.

FIG. 18 shows an example where one personal computer 20 is positioned under a cable modem 21 and plural users employing the personal computer 20 are respectively registered as a system user.

FIG. 19 is a relational table of explaining the management system corresponding to FIG. 18.

### DESCRIPTION OF THE PREFERRED EMBODIMENTS

Throughout the following descriptions, the same reference numerals are used to denote and identify corresponding or identical components.

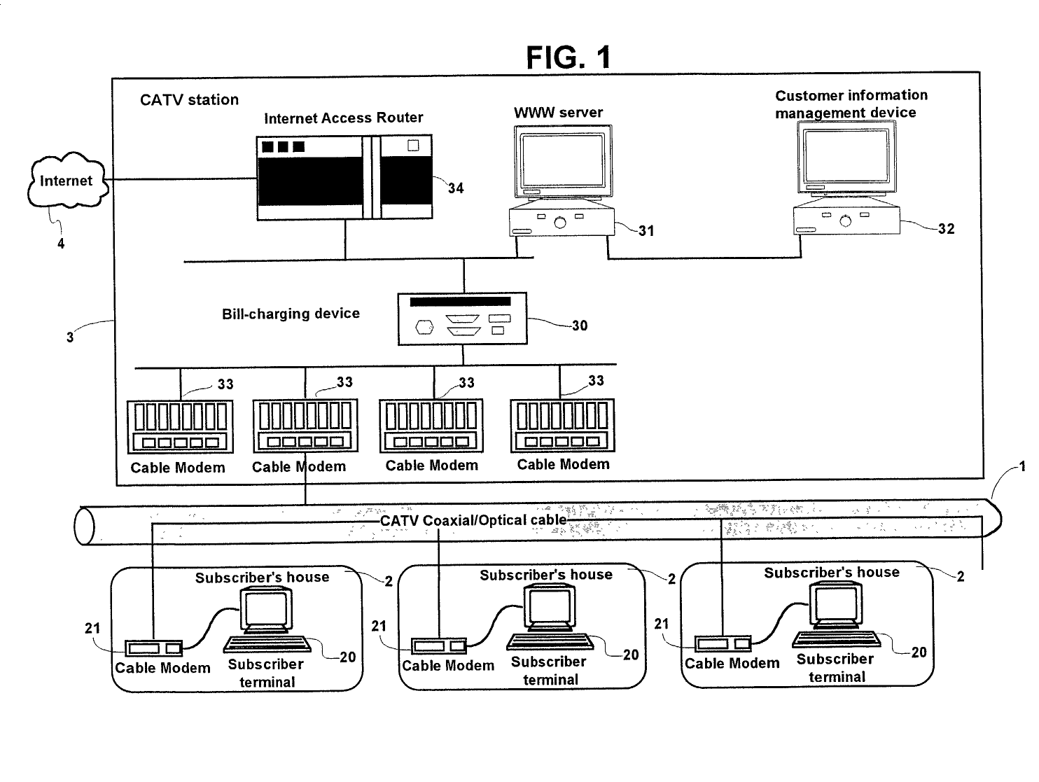

FIG. 1 shows one embodiment according to the present invention. In FIG. 1, a structural example is shown, in which a CATV network is employed as an IP network to provide an Internet connection service for end users.

In the structural example, plural end users, i.e., subscriber terminals 20 in subscriber houses 2, are connected through cable modems 21 to a CATV transmission path 1, which is formed by a coaxial or optical cable. In addition, a CATV station 3 is located between the Internet 4 and each subscriber terminal 2 as a provider.

Provided at the CATV station 3 are a bill-charging device 30, a WWW server 31 and a customer information management service 32. The bill-charging device 30 is connected through cable modems 33 for connecting each of the plural networks to the transmission path 1, to accommodate the subscriber houses 2 side. The bill-charging device 30 is further connected to the WWW server 31 and the Internet 4 through a router 34.

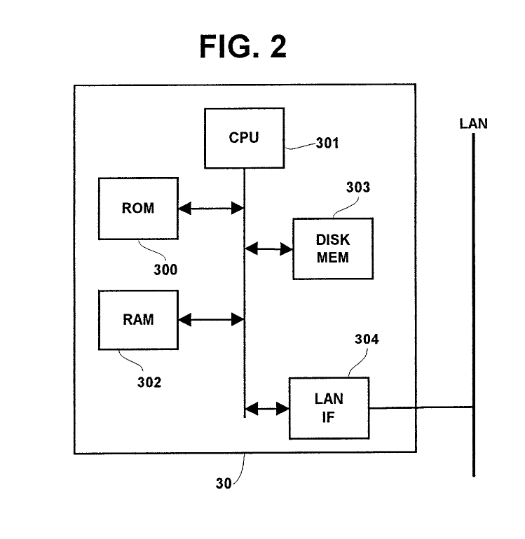

The bill-charging device 30 has a structure shown in FIG. 2 as one embodiment. A CPU 301 of the bill-charging device 30 executes and controls a control program, which is stored in a ROM 300, and performs predetermined operations. A RAM 302 stores setting information transmitted from the WWW server 31, which is described later.

A disk memory 303 stores billing data. The billing-charging device 30 is connected through its LAN interface 304 to a LAN transmission path to facilitate communications with the cable modems 33, the WWW server 31 and the router 34.

When the plural subscriber terminals 20 are connected to the transmission path 1, which is formed by a CATV coaxial or optical cable, for employing a CATV network as an IP network, a personal computer is usually used as a subscriber terminal 20 (Hereinafter, it is called PC).

The PC is equipped with a network card (NIC) employing a carrier sense multiple access/collision detection (CSMA/CD) method. Then, connection of the network card to the cable modem 21 makes it possible to facilitate communications each other. A specification of the cable modem has been standardized in MCNS 802.14 of the Institute of Electrical and Electronics Engineers (IEEE).

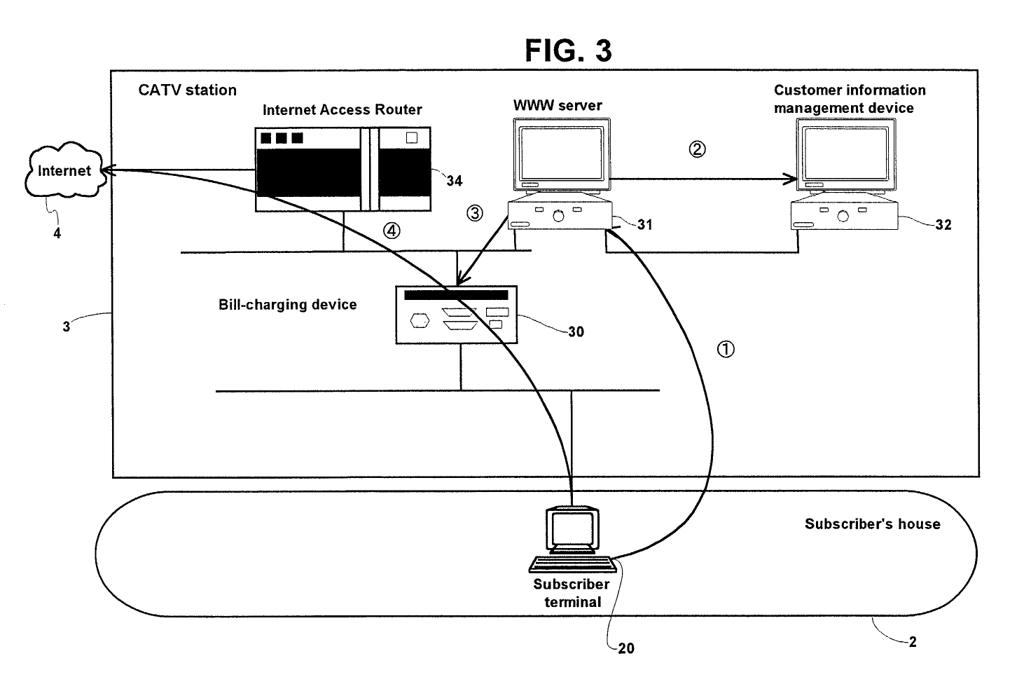

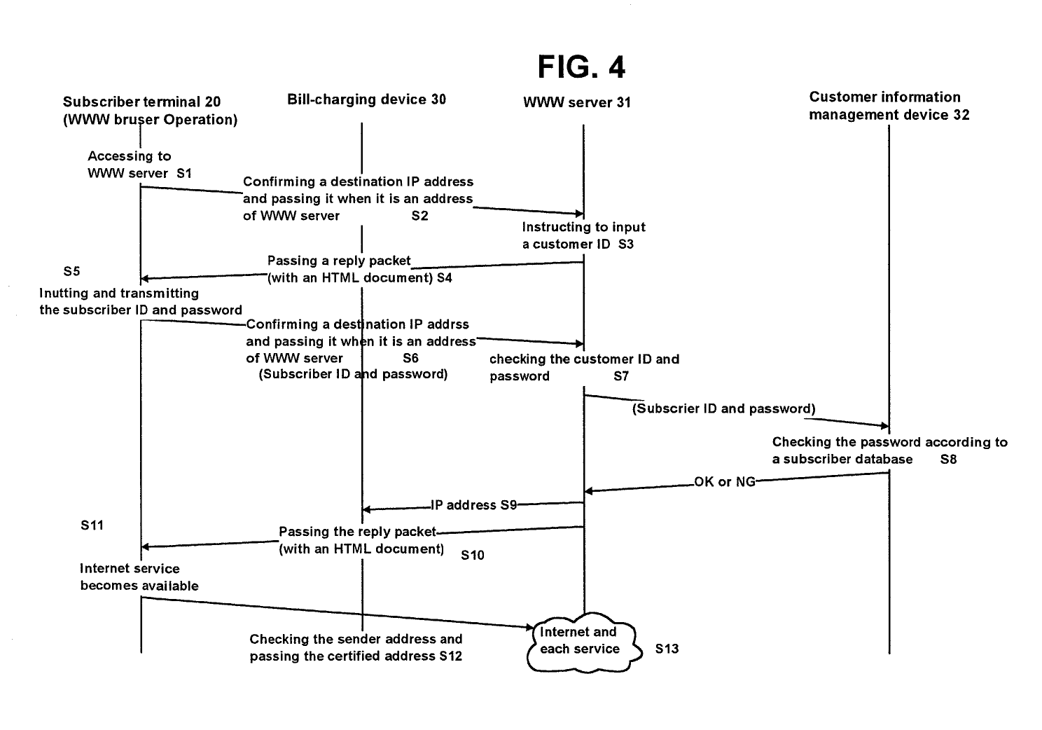

FIG. 3 is an explanatory diagram of a concept of a procedure for starting the Internet connection according to the present invention. FIG. 4 is a sequential flowing chart corresponding to the concept shown in FIG. 3. In FIGS. 3 and 4, a subscriber terminal 20 transmits an IP address of the WWW server 31 with the own IP address as a request of connecting to the Internet 4 to access the WWW server 31, at first (STEP S1: refer to \mathring{1} of FIG. 3).

The transmitted IP address of the WWW server 31 is passed through the bill-charging device 30. Then, the bill-charging device 30 confirms the input IP address, passes the IP address of the WWW server 31 and aborts other than the IP address (STEP S2).

Then, the WWW server 31 receives the IP address of the WWW server 31 passed through the bill-charging device 30. The WWW server 31 transmits data of instructing the subscriber to input the registered customer ID as a reply packet with an HTML document (STEP S3).

The bill-charging device 30 passes the reply packet, as it is, and transmits the reply packet for the subscriber terminal 20, sending the request of connecting the Internet 4 (STEP S4). An indication for instructing the subscriber to input his subscriber ID is displayed with an HTML document on the monitor of the subscriber terminal 20. Therefore, the subscriber inputs the subscriber ID and the password according to the indication and transmits the data input by him or her (STEP S5).

The bill-charging device 30 confirms the destination IP address again, and passes the subscriber ID and the password transmitted from the subscriber terminal 20, as they are (STEP S6). Therefore, the WWW server 31 receives the subscriber ID and the password, and requests the customer information management device 32 to inquire the subscriber ID and the password (STEP S7: refer to \mathring{2} of FIG. 3).

The customer information management device 32 includes a subscriber database, which is described later as one example. The customer information management device 32 checks the subscriber ID and the password according to the subscriber database. At this checking process, the customer information management device 32 informs the result to the WWW server 31, i.e., the device 32 returns the result of OK, when the ID and password are coincident with those of the subscriber database, or the result of NG, when they are not coincident with those of the database (STEP S8).

When receiving the result of OK from the customer information management device 32, the WWW server 31 informs the sender IP address to the bill-charging device 30 (STEP S9: refer to \mathring{3} of FIG. 3). The WWW server 31 concurrently transmits a replay packet with an HTML document to the sender terminal 20 (STEP S10).

Thereby, the Internet service becomes available at the sender terminal 20 (STEP S11). Then, the subscriber transmits an address to connect the Internet service from the subscriber terminal 20. The subscriber terminal 20 informs the bill-charging device 30 that the IP address of the sender terminal 20 is certified by the WWW server 31. Then, the bill-charging device 30 checks whether or not the IP address of the sender terminal 20 is coincident with the IP address stored in the RAM 302 (refer to FIG. 2) (STEP S12).

When the subscriber terminal has the certified IP address, the billing-charging device 30 transmits an address for accessing the router 34. Thereby, the Internet connection system becomes available at the sender terminal 20 (STEP S13: \mathring{4} of FIG. 3).

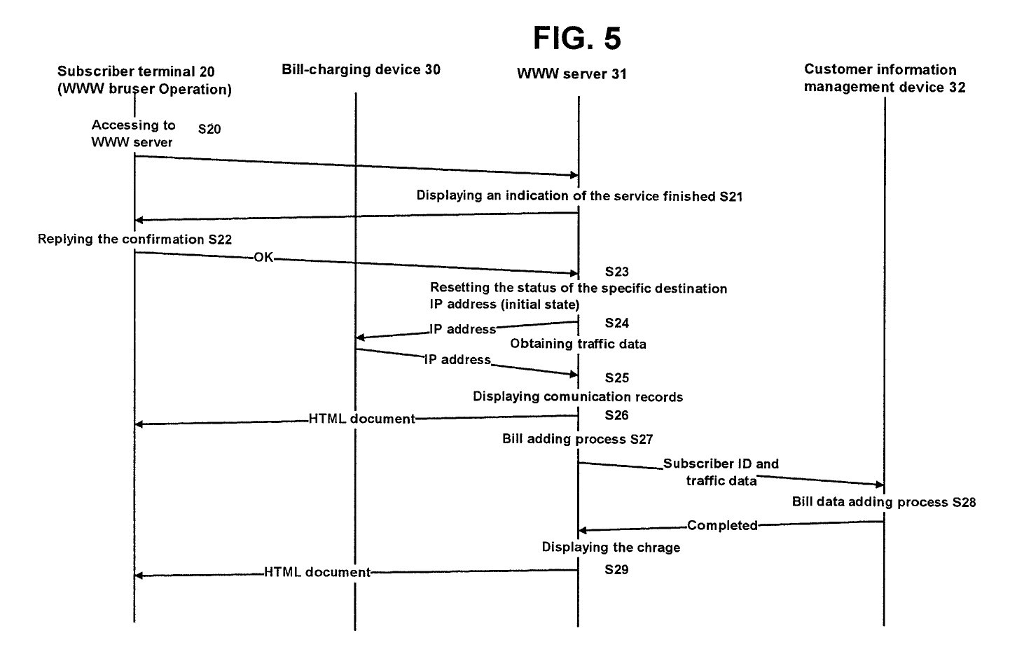

FIG. 5 is a sequential flowing chart, when the subscriber finishes connecting the Internet connection service. When the subscriber, who receives the Internet connection service at the subscriber terminal 20, finishes connecting to the service, the subscriber accesses the WWW server 31, again (STEP S20). The WWW server 31 confirms that the subscriber accesses from the terminal 20 having the same IP address as that of the sender terminal 20, and transmits a HTML document, which indicates the service finished, to the terminal 20 (STEP S21).

The subscriber inputs a reply message showing that he confirms to finish connecting the service from the subscriber terminal 20 on the indication of the service finished (STEP S22). When receiving the reply message of confirming to finish connecting the service, which is transmitted from the terminal 20, the WWW server 31 resets the status for the terminal 20 having the IP address to an initial status (STEP S23). Therefore, the subscriber at the terminal 20 should start executing a connection requesting process at the step S1 of FIG. 4 to connect the Internet connection service again.

Then, the WWW server 31 further informs the bill-charging device 30 of the IP address of the terminal 20, from which the reply message of confirming to finish the service is transmitted (STEP S24). In response to the information, the bill-charging device 30 replies traffic data, i.e., a packet flowing ratio of the IP address from the time of starting the Internet connection to the time of finishing the Internet connection, to the WWW server 31 (STEP S25).

Therefore, the WWW server 31 transmits the indication of communication records to the subscriber terminal 20 with an HTML document (STEP S26). The WWW server 31 concurrently transmits the subscriber ID and the traffic data to the customer information management device 32 (STEP S27).

The customer information management device 32 adds the bill based on the traffic data, according the received subscriber ID (Billing data adding process) (STEP S28). When finishing the billing data adding process, the customer information management device 32 transmits an information of completing the process to the WWW server 31.

When receiving the information of the completion, the WWW server 31 displays the charge for the Internet connection service on the subscriber terminal 20 with an HTML document (STEP S29).

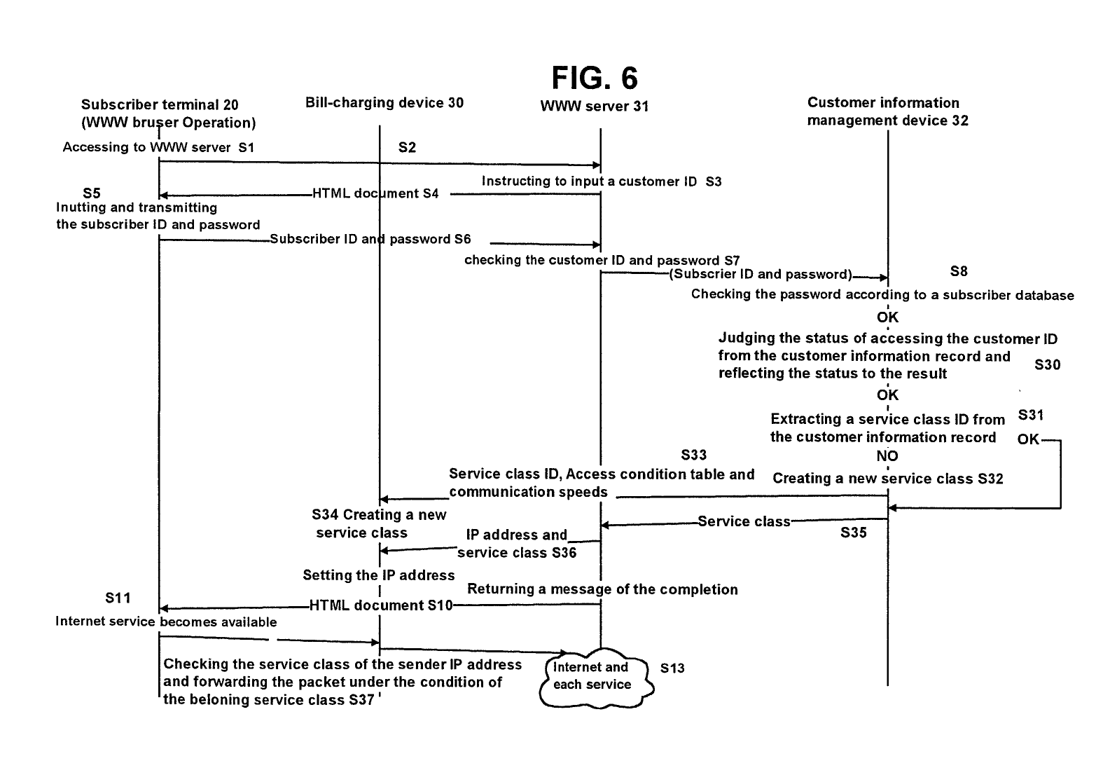

FIG. 6 is a sequential flowing chart of an embodiment, in which the processes of FIG. 4 is further extended. Before the explanation of FIG. 6, information stored in the customer information management device 32 and the bill-charging device 30 will be now explained.

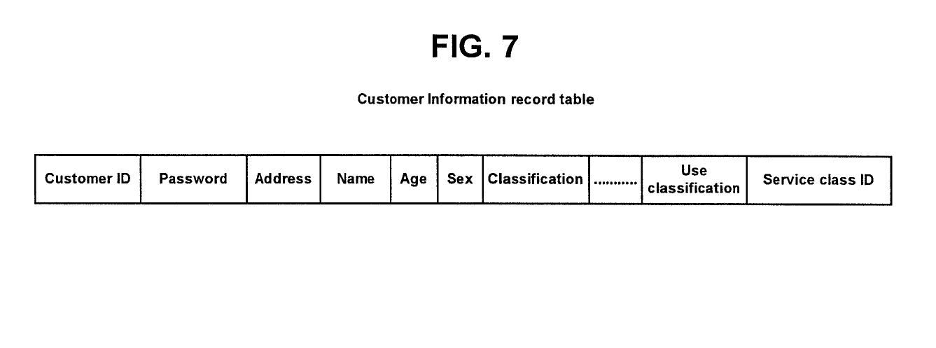

FIG. 7 shows a customer information record table registered and formed in each subscriber terminal 20, of which data is stored in the customer information management device 32. A customer ID means an identification code given to each subscriber terminal 20. In the table, information such as a password, an address, a name, an age, a sex, and a classification are recorded following to the customer ID.

A use classification and a service ID are specially added according to the present invention. The use classification is used to identify the status such that the service is available, the service is suspended because of the customer's reason, or the service is suspended because of nonpayment.

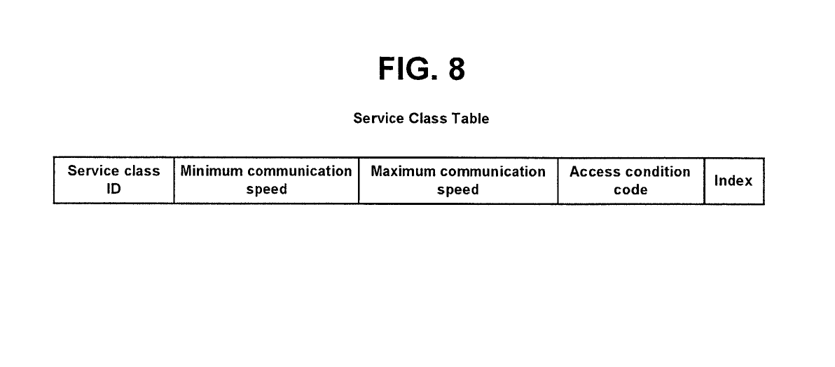

The service ID is used to identify the service class. The service class table is shown in FIG. 8. In other words, a minimum communication speed, a maximum communication speed and an access condition code are prescribed in each service class ID.

The minimum communication speed is used to define either the speed on using the service is guaranteed or there is no limitation. The maximum communication speed is used to define either the speed on using the service is guaranteed or there is no limitation.

An index is used to define whether a class is already created in the bill-charging device 30 or not.

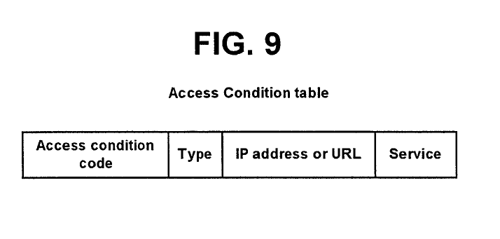

In an access condition table shown in FIG. 9, a type, an IP address or URL and a service are defined in each access condition code. The access condition code is used to indicate a group of access limitation. The type shows whether there is no access limitation or not, and sets whether the IP address following to the type is permitted or not.

The IP address or URL shows whether or not the IP address or URL is permitted or not.

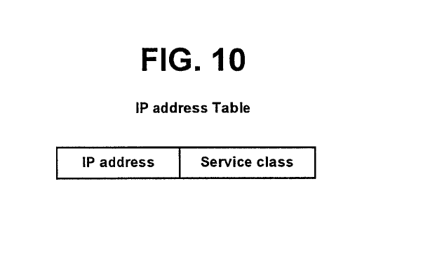

The service shows a service port of the specified IP address. On the other hand, the bill-charging device 30 maintains an IP address table shown in FIG. 10. In the table, the IP address and the service class ID are defined.

The WWW server 31 informs the bill-charging device 30 of the registrations to the IP address table. In addition, the service class table shown in FIG. 8 and the access condition table in FIG. 9 are copied and created at the bill-charging device 30.

However, an item of the index of the service class table of FIG. 8 is omitted in the bill-charging device 30. That is because the index is used so that the customer information management device 32 judges whether the service class table is already created or not at the bill-charging device 30.

Returning to FIG. 6, the processes at the steps S1 to S8 are the same as those in FIG. 4. At the step S8, the customer information management device 32 checks the password from the subscriber database, according to the customer information record table shown in FIG. 7. The device 32 judges the password is certified, when the password is already registered.

Then, the customer information management device 32 judges the status of the use classification, according to the customer information record. The result is reflected for the information to be transmitted to the WWW server 31 (STEP S30). The device 32 further extracts the service class ID from the customer information record (STEP S31).

When the service class ID is not registered on the service class table of FIG. 8, the device 32 can not extract the service class ID from the customer information record. Therefore, the device 32 creates a new service class, and registers it in the service class table (STEP S32).

The customer information management device 32 informs the bill-charging device 30 of the access condition table and communication speeds with the created service class ID to the bill-charging device 30 through the WWW server 31 (STEP S33). According to this, the bill-charging device 30 creates the same service class as that of the customer information management device 32 (STEP S34).

On the other hand, when the customer information management device 32 can extract the service class ID from the customer information records, the extracted service class is informed to the WWW server 31 (STEP S35).

Thereby, the WWW server 31 informs the bill-charging device 30 of the sender IP address and the service class (STEP S36). Then, the bill-charging device 30 can set an IP address of a terminal, from which the subscriber can connect the Internet connection service.

The WWW server 31 concurrently informs the subscriber terminal 20 of the completion of certifying the IP address with an HTML document (STEP S10). Thereby, the Internet service becomes available at the subscriber terminal 20 (STEP S11). When connecting the Internet service, the subscriber terminal 20 transmits the own IP address with the destination IP address or URL.

The bill-charging device 30 checks the service class corresponding to the sender IP address, and transmits a packet to the destination with a condition of the service class to be belonging (STEP S37).

As is described above, even if plural users share one terminal connected to the CATV network, it becomes possible to easily regulate accesses with various conditions by providing a subscriber database on the customer information management device 32 to register a service condition according to the sender IP address.

In addition, as the bill-charging device 30 receives the certified sender IP address and the information of confirming to finish connecting the service from the WWW server 31, the bill-charging device 30 can correctly count a packet flowing ratio while this connecting interval.

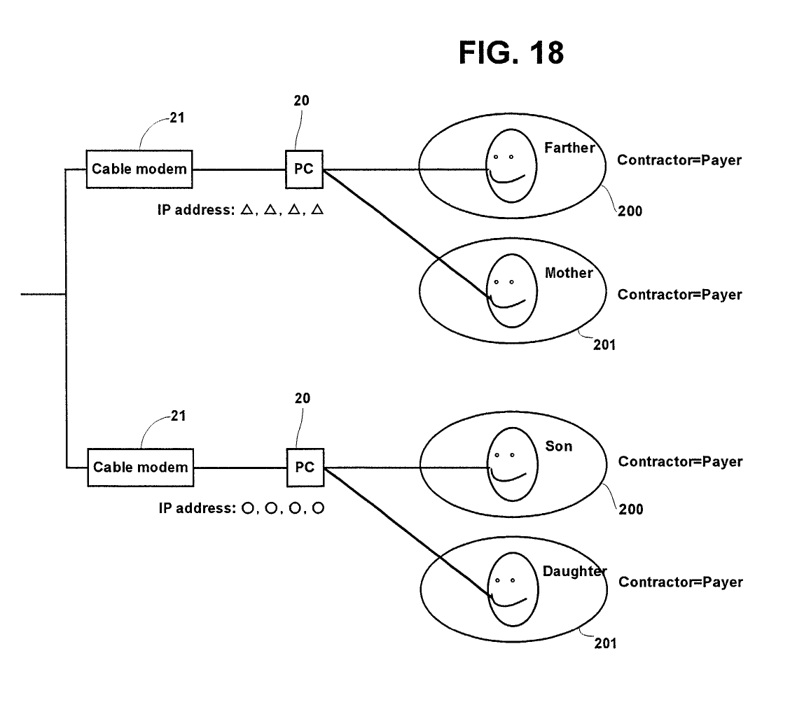

In here, an example where plural contractors 2 exist under one cable modem 21 (refer to FIG. 1) on a system, in which they use a CATV network to connect the Internet, as described above, will be now considered. FIG. 18 shows one example where one personal computer 20 exists under the control of one cable modem 21, and plural users employing the personal computer 20 are respectively registered as system users.

In other words, the example of FIG. 18 shows a case where a personal computer 20 having an IP address of Δ,Δ,Δ,Δ,Δ is employed by a father and a mother, who are both contractors, i.e., payers of the charge of using the service.

Simultaneously, a personal computer 20 having an IP address of ∘,∘,∘,∘ is used by a son and a daughter, who are both contractors, i.e., payers of the charge of using the service.

Accordingly, in the example of FIG. 18, even if the plural users are belonging to the same family or company, the plural user's pays in the same family or company can not be paid in a lump. When plural users connect the Internet under the control of the same cable modem, one contract for one user is required. Additionally, each user pays the charge of using the service by her or him. That makes operations of a CATV company complex.

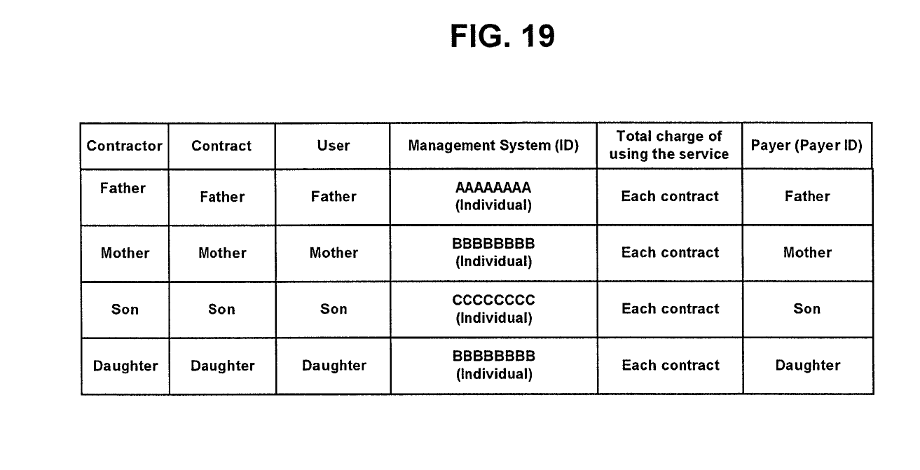

Alternatively, as shown in FIG. 19, when plural users, i.e., a father, a mother, a son and a daughter, connect the Internet under the control of the same cable modem, the contractor is a user, and each user has a management system ID and becomes a payer of using the service. Therefore, that makes it difficult to separate a contractor from a payer or to pay the family's pay or the company's pay in bundle.

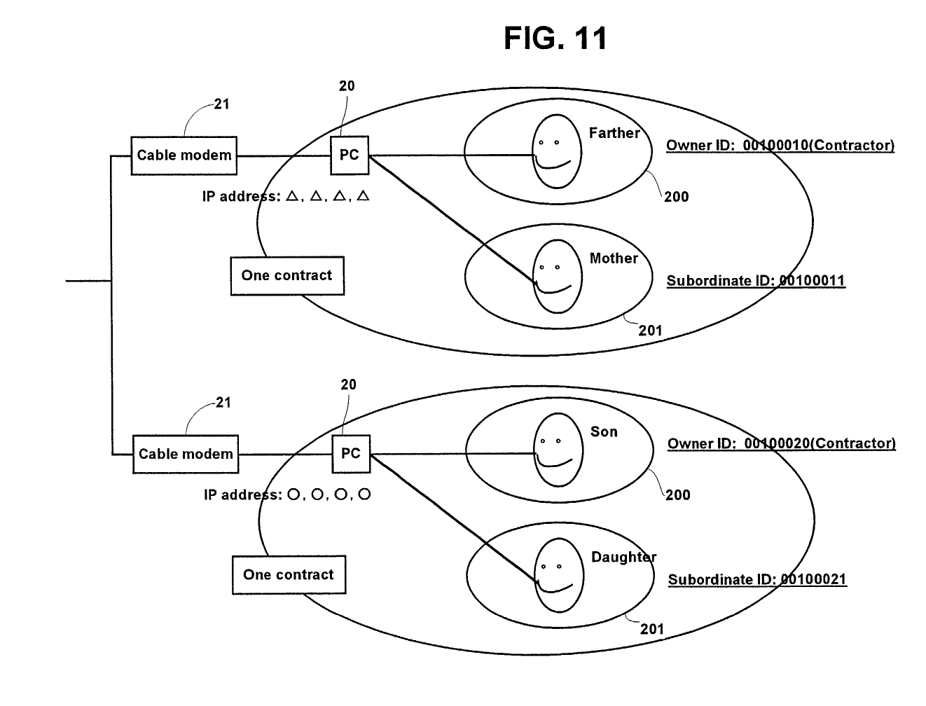

FIG. 11 shows one example to solve the above-described problem. The example has a management system having an owner ID (contractor) and a subordinate ID (one user accompanying to the contractor) under the control of one IP address corresponding to one cable modem. The plural users are handled as one contractor.

In FIG. 11, a personal computer 20 having the IP address of Δ,Δ,Δ,Δ is used by a father, who is a contractor, having an owner ID of 001000010 and a mother having a subordinate ID of 00100011.

Similarly to that, a personal computer 20 having the IP address of ∘,∘,∘,∘ is used by a son, who is a contractor, having an owner ID of 00100020, and a daughter having a subordinate ID of 00100021.

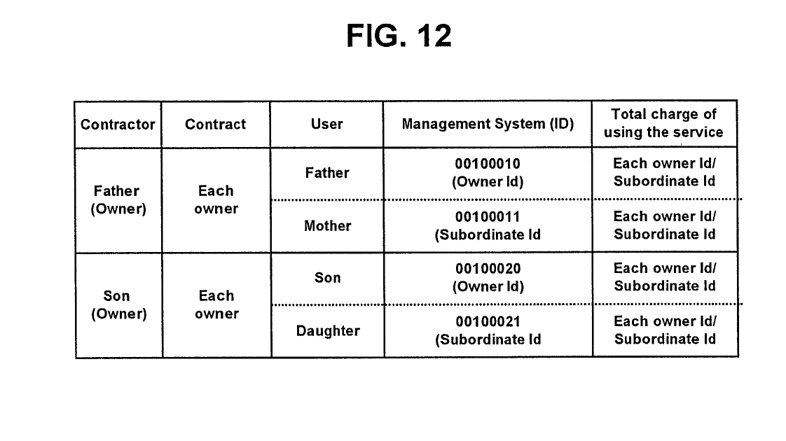

In other words, although the members of the family have individual management system Ids, as shown in FIG. 12, a contract is made in every owner. In addition, the charge of using the service can be paid in bundle of the owner and subordinate IDs.

In FIG. 12, a number of eight figures are used as a management system ID. The first figure of the number is for spare, the second and third figures mean the node, the fourth, fifth and seventh figures mean a serial number of the cable modem in the node, and the eighth figure means a serial number of the subscriber employing the cable modem. However, “0” of the serial number is an owner ID and the others are subordinate Ids. The same number is used in the following embodiments.

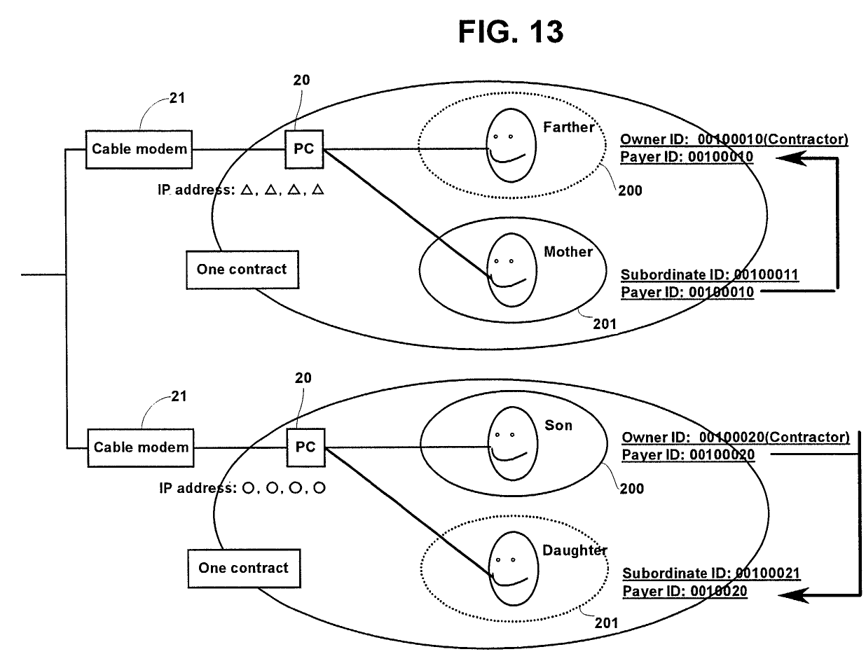

FIG. 13 is another embodiment where a payer ID is installed. A personal computer 20 having an IP address of Δ,Δ,Δ,Δ is used by a father and a mother. The father is a contractor, having an owner ID of 00100010 and a payer ID of 001000010, and the mother has a subordinate ID of 00100011, which is different from the father's owner ID, and the same payer ID of 00100010 as that of the father.

Similarly to that, a personal computer 20 having an IP address of ∘,∘,∘,∘ is used by a son and a daughter. The son is a contractor, having an owner ID of 00100020 and a payer ID of 00100020, and the daughter has a subordinate ID of 00100021 and the same payer ID of 00100020 as that of the son.

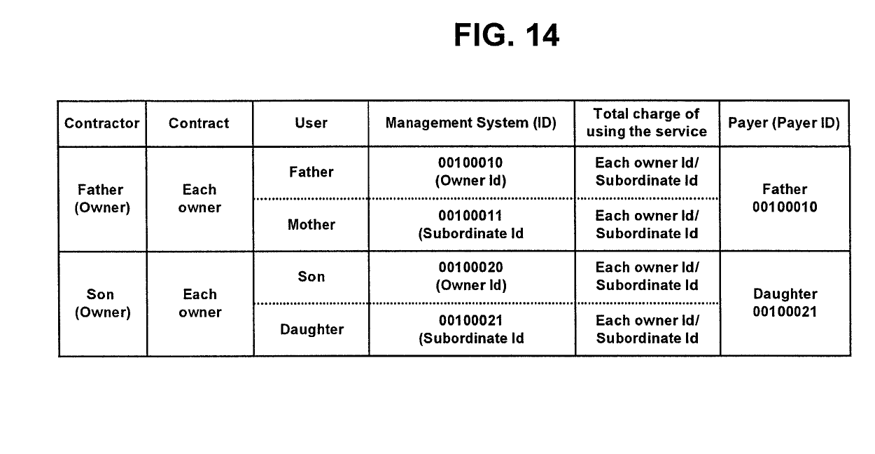

Accordingly, it becomes possible to pay the father's pay and the son's pay in bundle, as shown in FIG. 14.

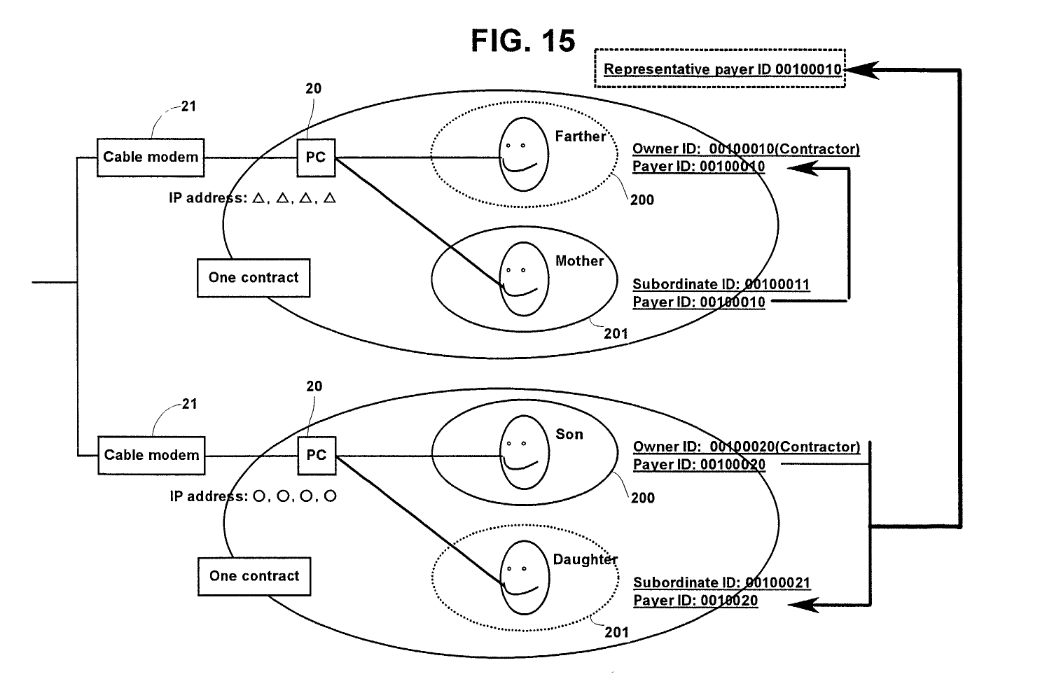

In an example of FIG. 15, a personal computer 20 having an IP address of Δ,Δ,Δ,Δ is used by a father and a mother. The father is a contractor, having an owner ID of 00100010 and a payer ID of 00100010, and the mother has an subordinate ID of 00100011 and the same payer ID of 00100010 as that of the father.

On the other hand, a personal computer 20 having an IP address of ∘,∘,∘,∘ is used by a son and a daughter. The son is a contractor, having an owner ID of 00100020 and a payer ID of 00100020, and the daughter has a subordinate ID of 00100021, which is different from the son's owner ID, and the same payer ID of 00100020 as that of the son.

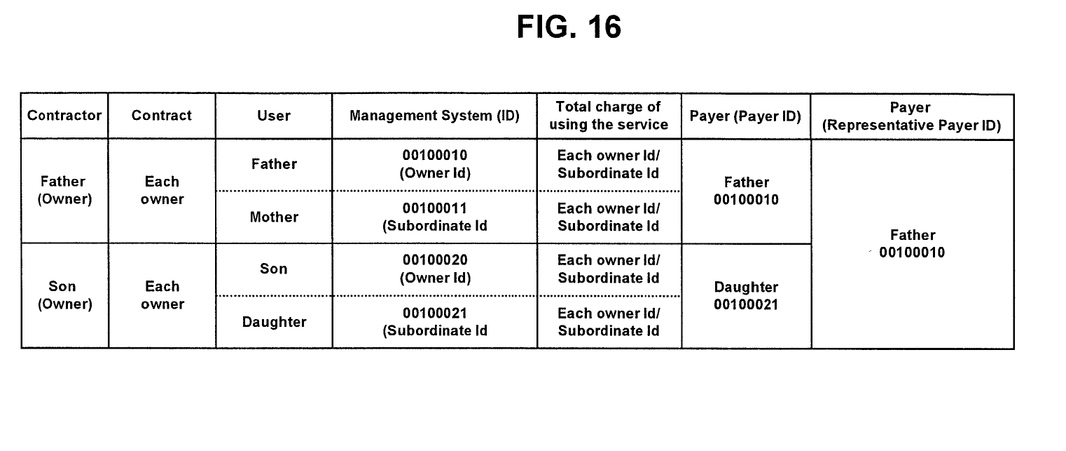

In the example of FIG. 15, additionally, as shown in FIG. 16, a representative payer ID of 00100010 is provided. In other words, 10010010 of the father's payer ID is registered as a representative payer ID. Thereby, it becomes possible to pay the whole family or company pay in bundle.

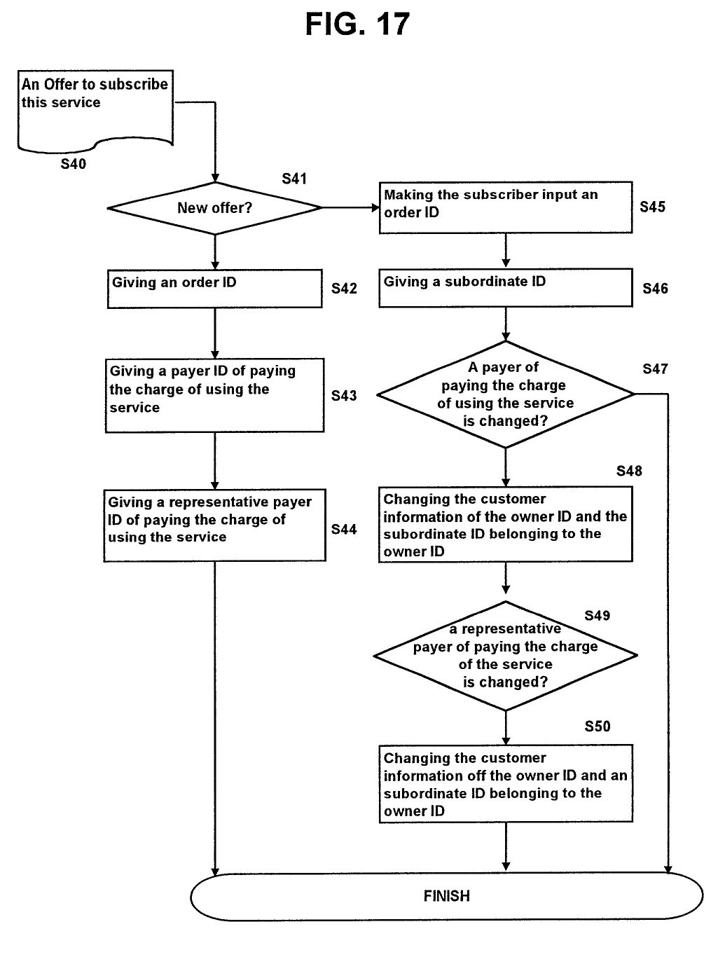

FIG. 17 is a flow chart of subscriber management processes according to the present invention. When one person offers to subscribe the Internet service (STEP S40), it is judged whether or not this is a first offer from the person (STEP S41). This judgement can be performed by referring the subscriber database of the customer information management device 32 through an input device, not shown in FIG. 17.

When it is a new offer, an order ID is given to the person (STEP S42). Then, a payer ID of paying the charge is attached to the person (STEP S43). In addition a representative payer ID is given to the person (STEP S44).

If it is not a new offer at the step S41, the CPU instructs the person to input the order ID (STEP S45). Then, a subordinate ID is attached to the person (STEP S46). The CPU confirms whether or not the payer of paying the charge is changed (STEP S47). When the payer is changed, the changed order and subordinate ID in the subscriber database are changed (STEP S48).

Then, it is confirmed whether or not the representative payer of using the service is changed (STEP S49). When the representative payer is changed, the subordinate ID stored in the subscriber database is changed (STEP S48).

As is described in accompanying with the drawings, it becomes possible to connect a terminal having a correct IP address to the Internet through a bill-charging device by referring a database of the customer information management device under the control of a WWW server according to the present invention. Then, it is also possible to change the mode of using the Internet connection service from a subscriber terminal, according to a service content registered in the database.

The present invention may be embodied in other specific forms without departing from the sprit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An Internet connection method for use in an Internet connection system having subscriber terminals connected to an IP network, a WWW server, receiving a request for connecting the subscriber terminal to the Internet, a customer information management device, storing information of the subscriber terminal, and a bill-charging device controlling connection of the subscriber terminals to the Internet, comprising the steps of:
transmitting an Internet connection request from the subscriber terminal,
receiving information of the subscriber terminal corresponding to an IP address of the subscriber terminal at the WWW server from the customer information management device; and
informing the bill-charging device whether or not the subscriber terminal is connected to the Internet according to the information of the subscriber terminal at the WWW server.

2. The Internet connection method according to claim 1,
wherein the WWW server receives a request of finishing connecting to the Internet from the subscriber terminal and informs the bill-charging device to disconnect the subscriber terminal with the Internet.

3. The Internet connection method according to claim 1,
wherein the information of the subscriber terminal stored in the customer information device includes information of services that the subscriber terminal can receives, and the connection from the subscriber terminal to the Internet is controlled according to the service information.

4. An Internet connection system comprising;
a subscriber terminal connected to an IP network;
a WWW server, which receives a request of connecting to the Internet from the subscriber terminal;
a customer information management device, which stores information of the subscriber terminal; and
a bill-charging device, which controls to connect to the Internet from the subscriber terminal;
wherein the WWW server receives the information of the subscriber terminal corresponding to the IP address of the subscriber terminal, which transmits the request of connecting to the Internet, from the customer information management device, and informs the bill-charging device whether or not the subscriber terminal can connect to the Internet according to the information of the subscriber terminal.

5. The Internet connection system according to claim 4,
wherein when the WWW server receives the request of finishing to connect to the Internet from the subscriber terminal, the WWW server informs the bill-charging device that the subscriber terminal is disconnected from the Internet.

6. The Internet connection system according to claim 5,
wherein the bill-charging device counts and stores a packet flowing ratio from the time of transmitting a request of connecting to the Internet from the subscriber terminal to the time of finishing to connect to the Internet.

7. The Internet connection system according to claim 4,
wherein the WWW server, the customer information management device and the bill-charging device are located on a CATV station, and the IP network is constituted by employing a CATV network.

8. The Internet connection system according to claim 4,
wherein the information of the subscriber terminal, which is stored in the customer information device, includes information of services that the subscriber terminal can receive and obtain, and the WWW server controls the bill-charging device to connect the subscriber terminal to the Internet, according to the service information.

9. A subscriber management system, for use in a system where an Internet connection service is provided by an IP network employing a CATV network,
wherein a management table having an owner ID to receive the connection service and a subordinate ID belonging to the owner ID is provided under a control of one IP address.

10. The system according to claim 9,
wherein a payer ID of paying the charge of using the service can be registered in the management table.

11. The system according to claim 9 or 10,
wherein a representative payer ID of paying the charge of using the service can be registered in the management table.
